(19) United States
(12) Patent Application Publication
(10) Pub. No.: US 2023/0002285 A1
(43) Pub. Date: Jan. 5, 2023

(54) Method for Treating and Disposing Wastewater Grit

(71) Applicant: Marquette University, Milwaukee, WI (US)

(72) Inventors: Zhongzhe Liu, Milwaukee, WI (US); Baolin Wan, Milwaukee, WI (US); Kyana Young, Milwaukee, WI (US)

(21) Appl. No.: 17/781,681

(22) PCT Filed: Dec. 2, 2020
(86) PCT No.: PCT/US2020/062904

§ 371 Date: Jun. 1, 2022

Related U.S. Application Data
(60) Provisional application No. 62/942,420, filed on Dec. 2, 2019.

(51) Int. Cl. C04B 35/622; C04B 35/447

(52) U.S. Cl. CPC C04B 35/62204; C04B 35/447; C04B 2235/447

(57) ABSTRACT

Disclosed herein are methods for treating wastewater grit to inactivate any pathogens that are present in the grit and for forming a solidified material comprising wastewater grit such as a chemically bonded phosphate ceramic (CBPC). The CBPC may be utilized in methods for repairing depressions in a road surface that include applying the uncured CBPC to the depression in the road surface and allowing the CBPC to cure.

### CROSS-REFERENCE TO RELATED PATENT APPLICATIONS

The present application claims the benefit of priority under 35 U.S.C. § 119(e) to U.S. Provisional Application No. 62/942,420, filed Dec. 2, 2019, the content of which is incorporated herein by reference in its entirety.

### BACKGROUND

The field of the invention relates to wastewater grit and methods of treating wastewater grit to generate useful products. In particular, the field of the invention relates to methods of treating wastewater grit in order to inactivate pathogens, such as Escherichia coli (E. coli), which are present in the wastewater grit and to prepare a solid material that comprises the wastewater grit.

Wastewater grit is non-biodegradable heavy solid material that is generated during water reclamation. Wastewater grit majorly consists of sand and gravel, and also contains pathogens and some impurities such as eggshells, bone chips, seeds, coffee grounds, and large organic particles (USEPA, 2003). Large water resource recovery facilities produce a high volume of wastewater grit, and the amount can rise in winter due to the use of sand for winter maintenance (The Seattle Times, 2009). Wastewater grit is directly landfilled instead of being reused or recovered in the current practice. Landfilling is costly and unsustainable, and the reusable values of wastewater grit cannot be further tapped. Hence, there is an urgent need for better methods for disposing and/or recycling wastewater grit.

### SUMMARY

Disclosed are methods for the treatment of wastewater grit to inactivate pathogens and prepare solidified materials that include wastewater grit. In one embodiment, the disclosed subject matter relates to methods for treating wastewater grit with an alkaline agent to inactivate any pathogens that are present in the grit and a phosphate salt to form a solidified material comprising wastewater grit such as a chemical bonded phosphate ceramic (CBPC).

In some embodiments, the present invention relates to methods for treating wastewater grit by mixing the wastewater grit with an alkaline earth metal oxide or an alkaline earth metal hydroxide. Suitable alkaline earth metal oxides may include but are not limited to CaO, MgO, BeO, SrO, BaO, and any combination thereof. Suitable alkaline earth metal hydroxides may include but are not limited to Ca(OH)₂, Mg(OH)₂, Be(OH)₂, Sr(OH)₂, Ba(OH)₂, and any combination thereof.

In some embodiments, a phosphate salt is added to the wastewater grit to produce a chemically bonded phosphate ceramic (CBPC). Suitable phosphate salts may include but are not limited to (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, KH₂PO₄, and any combination thereof

The disclosed treated wastewater grit may have a relative high pH. In some embodiments, the treated wastewater grit may have a pH of at least about 8, 9, 10, 11, or higher.

In some embodiments, the treated wastewater grit may comprise (i) about 1%, 2%, 3%, 4%, 5%, 10%, 15%, 20%, 25%, 30%, 35%, 40%, 45%, to 50% by weight wastewater grit, (ii) about 0.1%, 0.2%, 0.3%, 0.4%, 0.5%, 0.6%, 0.7%, 0.8%, 0.9%, 1.0%. 1.1%, 1.2%, 1.3%, 1.4%, to 1.5% by weight CaO, (iii) about 1%, 2%, 3%, 4%, 5%, 6%, 7%, 8%, 9%, 10%, 11%, 12%, 13%, 14%, 15%, 20%, to 25% by weight MgO, and (iv) about 3%, 4%, 5%, 6%, 7%, 8%, 9%, 10%, 15%, 20%, 25%, 30%, 35%, 40%, 45%, 50%, 55%, 60%, 65%, 70%, to 75% by weight phosphate salt.

In some embodiments, the CBPC prepared by the disclosed methods is cured, for example the CBPC prepared by the disclosed methods may be cured at a relatively low temperature. The relative low temperature may be a temperature of about −30° C., −20° C., −10° C., 0° C., 10° C., 20° C., 30° C., 40° C., 50° C., 60° C., to about 70° C.

In some embodiments, the present invention relates to methods of preparing CBPC. The CBPC may be prepared by treating wastewater grit with an alkaline earth metal oxide or hydroxide and phosphate salt.

In yet other embodiments, the present invention relates to methods of applying CBPC to a road surface or to a depression on the road, for example, to achieve road reparation. The disclosed methods may include (a) treating wastewater grit with an alkaline earth metal oxide or an alkaline earth metal hydroxide to form treated wastewater grit; (b) adding a phosphate salt to the treated wastewater grit to form a chemically bonded phosphate ceramic (CBPC); and (c) applying the CBPC to a road surface or to a depression therein; and allowing the CBPC to cure. The CBPC utilized as such may be referred to as a Grit Assisted Patch (GAP) comprising the CBPC.

In other embodiments, the present invention relates to a treated wastewater grit composition. The treated wastewater grit composition may include (i) 1%, 2%, 3%, 4%, 5%, 10%, 15%, 20%, 25%, 30%, 35%, 40%, 45%, to 50% by weight wastewater grit, (ii) about 0.1%, 0.2%, 0.3%, 0.4%, 0.5%, 0.6%, 0.7%, 0.8%, 0.9%, 1.0%. 1.1%, 1.2%, 1.3%, 1.4%, to 1.5% by weight CaO, and (iii) about 1%, 2%, 3%, 4%, 5%, 6%, 7%, 8%, 9%, 10%, 11%, 12%, 13%, 14%, 15%, 20%, to 25% by weight MgO. The treated wastewater grit composition further may include (iv) about 3%, 4%, 5%, 6%, 7%, 8%, 9%, 10%, 15%, 20%, 25%, 30%, 35%, 40%, 45%, 50%, 55%, 60%, 65%, 70%, to 75% by weight phosphate salt, for example, where the treated wastewater grit comprises solidified material.

### BRIEF DESCRIPTION OF THE FIGURES

FIG. 1. Schematic diagram of production and application of grit-based CBPC with pathogen inactivation.

FIG. 2. Pathogen density change (12 hours) with different raw grit loading and inactivation agent.

FIG. 3. Pathogen density change with different raw grit loading and inactivation time.

FIG. 4. Compressive strength (28 days) of grit-based CBPC with different raw grit loading at room temperature.

FIG. 5. Compressive strength of grit-based CBPC with different raw grit loading and curing time at room temperature.

FIG. 6. Compressive strength (28 days) of grit-based CBPC with different raw grit loading and curing temperature.

FIG. 7. Pothole repaired by GAP.

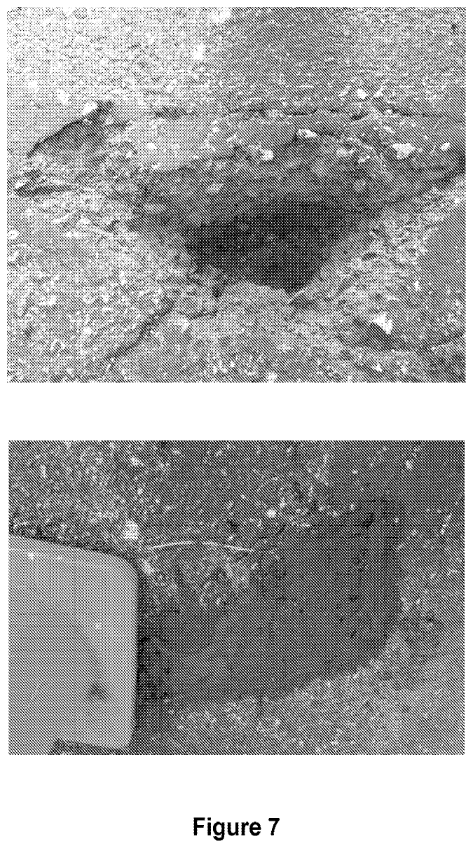

### DETAILED DESCRIPTION

The disclosed subject matter further may be described utilizing terms as defined below.

### Definitions

Unless otherwise specified or indicated by context, the terms “a”, “an”, and “the” mean “one or more.” For example, “a compound” or “an agent” should be interpreted to mean “one or more compounds” and “one or more agents,” respectively.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus <10% of the particular term and “substantially” and “significantly” will mean plus or minus >10% of the particular term.

As used herein, the terms “include” and “including” have the same meaning as the terms “comprise” and “comprising” in that these latter terms are “open” transitional terms that do not limit claims only to the recited elements succeeding these transitional terms. The term “consisting of” while encompassed by the term “comprising,” should be interpreted as a “closed” transitional term that limits claims only to the recited elements succeeding this transitional term. The term “consisting essentially of,” while encompassed by the term “comprising,” should be interpreted as a “partially closed” transitional term which permits additional elements succeeding this transitional term, but only if those additional elements do not materially affect the basic and novel characteristics of the claim.

The present disclosure describes a novel method for integrating wastewater grit and CBPC for pathogen inactivation and solidification. Before synthesizing the wastewater grit-based CBPC material, the pathogens remaining in the wastewater grit must be greatly reduced to protect the environment and public health.

Disclosed herein are methods for treating wastewater grit to inactivate any pathogens present in the wastewater grit and for forming a solidified material comprising the wastewater grit. The method typically includes addition of alkaline earth metal oxide, or hydroxide, and/or a phosphate salt.

As used herein, “wastewater grit” refers to solids found in wastewater. Wastewater grit contains sand, gravel, cinder, or other heaving solid materials that are heavier (higher specific gravity) than the organic biodegradable solids in the wastewater. Wastewater grit may also include eggshells, bone chips, seeds, coffee groups, and large organic particles, such as food waste and human waste.

As used herein, “pathogens” are any type of agent that can produce a disease. Typical pathogens include infectious microorganisms or agents, such as, but not limited to, viruses, bacterium, protozoans, prions, viroids, or fungi. As used herein, “pathogens” may include waterborne pathogens. Examples of bacterial pathogens may include, but are not limited to, species of Citrobacter, Enterobacter, Hafnia, Klebsiella, Escherichia, Salmonella, Sheigella, Vibrio, and Campylobacter. Examples of protozoan pathogens may include, but are not limited to species of Cryptosporidium and Giardia. Examples of viral pathogens may include, but are not limited to enteroviruses, adenoviruses, noroviruses, rotaviruses, and hepatitis A virus.

As used herein, “inactivation” of a pathogen is a method whereby a pathogen is killed or otherwise is rendered incapable of reproducing. In some embodiments, pathogen inactivation results from the treatment of wastewater grit. For example, pathogen inactivation may result from increasing the pH of the wastewater grit to about 8, 9, 10, 11, or higher, which effectively inactivates pathogens.

As used herein, a “pathogen load” refers to the concentration of pathogens (e.g. total coliforms and E. coli) per weight or volume of wastewater grit. Pathogens may include bacteria (e.g., coliform bacteria) and the total amount of bacteria (i.e., colony forming units (CFU)) per gram of wastewater grit may be utilized as a measure of pathogen load. Preferably, the disclosed treatment methods inactivate bacteria (e.g., coliform bacteria) in wastewater grit to a concentration per gram (CFU/g) of less than about 1000, 500, 100, 50, 40, 20, 10, 5, 4, 3, 2, or 1 CFU/g.

In one embodiment, the method comprising treating wastewater grit to inactivate any pathogens that are present in the wastewater grit comprises adding an alkaline earth metal oxide or an alkaline earth metal hydroxide to the wastewater grit. Non-limiting examples of alkaline earth metal oxide include CaO, MgO, BeO, SrO, BaO, and any combination thereof. In one embodiment, the alkaline earth metal oxide comprises or consists of a combination of CaO and MgO. Non-limiting examples of alkaline earth metal hydroxide include Ca(OH)₂, Mg(OH)₂, Be(OH)₂, Sr(OH)₂, Ba(OH)₂, and any combination thereof.

In one embodiment, the method comprises adding a phosphate salt to the wastewater grit. As used herein, a “phosphate salt” is any salt having a phosphate anion PO₄³⁻ or a hydrogenated phosphate ion such as the hydrogenphosphate anion H(PO₄)²⁻ or the dihydrogenphosphate anion H₂(PO₄)⁻. Suitable phosphate salts may include hydrated phosphate salts. Suitable phosphate salts may include so called acid-phosphates. Examples of suitable phosphate salt compounds may include, but are not limited to, (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, KH₂PO₄, and any combination thereof.

In one embodiment, the step of adding a phosphate salt to the wastewater grit produces a chemically bonded phosphate ceramic (CBPC). As used herein, “CBPC” refers to a dense and insoluble ceramic matrix. Typically, CBPC is formed by the combination of soluble oxides and/or hydroxides with a phosphate salt.

In one embodiment, the treated wastewater grit has a relative high pH. As used herein, a “relative high pH” is a pH of a solution that is greater than 7, preferably a pH greater than 8, or greater than 9, or greater than 10, or greater than 11. In a preferred embodiment, the treated wastewater grit has a pH of about 10. In another preferred embodiment, the treated wastewater grit has a pH greater than 12.

In some embodiments, the disclosed treated wastewater grit is composed of (i) about 1%, 2%, 3%, 4%, 5%, 10%, 15%, 20%, 25%, 30%, 35%, 40%, 45%, to 50% by weight wastewater grit, (ii) about 0.1%, 0.2%, 0.3%, 0.4%, 0.5%, 0.6%, 0.7%, 0.8%, 0.9%, 1.0%. 1.1%, 1.2%, 1.3%, 1.4%, to 1.5% by weight CaO, (iii) about 1%, 2%, 3%, 4%, 5%, 6%, 7%, 8%, 9%, 10%, 11%, 12%, 13%, 14%, 15%, 20%, to 25% by weight MgO, and optionally (iv) about 3%, 4%, 5%, 6%, 7%, 8%, 9%, 10%, 15%, 20%, 25%, 30%, 35%, 40%, 45%, 50%, 55%, 60%, 65%, 70%, to 75% by weight phosphate salt, for example, where the treated wastewater grit comprises solidified material.

In some embodiments, the method further comprises curing the CBPC at a relatively low temperature. As used herein, a “relatively low temperature” refers to a curing temperature of about −30° C., −20° C., −10° C., 0° C., 10° C., 20° C., 30° C., 40 ° C., 50 ° C., 60 ° C., to about 70 ° C. or ranges thereof. In a preferred embodiment, the curing temperature is about −20° C. to about 50° C. In a more preferred embodiment, the curing temperature is about −15° C. to about 40° C.

The disclosed CBPC may have a compressive strength that is suitable for a variety of applications. In some embodiments, the CBPC may have a compressive strength that is at least about 2, 3, 4, 5, 6, 7, 8, 9, or 10 MPa, or within a range bounded by any of these values.

The CBPC may have compressive strength which is measured relative to the concentration of raw wastewater grit loading in the CBPC. For example, the CBPC may have a compressive strength that is at least about 2, 3, 4, 5, 6, 7, 8, 9, or 10 MPa, or within a range bounded by any of these values, when the CBPC has a wastewater grit loading of about 1%, 2%, 3%, 4%, 5%, 10%, 15%, 20%, 25%, 30%, 35%, 40%, 45%, or 50% or higher, or within a range bounded by any of these values.

The CBPC may have a compressive strength which is measured after the CBPC has been allowed to cure for a period of time, for example, at least about 10 minutes, 20 minutes, 30 minutes, 40 minutes, 50 minutes, 60 minutes, 1 day, 2 days, 3 days, 4 days, 5 days, 6 days, 7 days, 14 days, 28 days, or within a range bounded by any of these values, at a temperature of −30° C., −20° C., −10° C., 0° C., 10° C., 20° C., 30° C., 40° C., 50° C., 60° C., to about 70° C., or within a range bounded by any of these values.

The disclosed CBPC may be applied to a road surface or a depression therein. As used herein, a “road surface” refers to a durable surface material laid down on an area intended to sustain vehicular or foot traffic, such as a road or walkway. As used herein a “depression” on a road surface is a surface area with slightly lower elevations than the surrounding areas. An example of a road surface depression is a “pothole,” an area where traffic has removed broken pieces of the road surface. Another example is a “rut,” an area worn into a road surface by the travel of wheels or skis. Other road surface depression examples include ravels and cracks, such as alligator cracks, edge cracks, block cracks, joint cracks, transverse cracks, and linear cracks. When utilized to repair depressions in a road surface, the CPBC may be referred to as a Grit Assisted Patch (GAP), where the GAP comprises the CPBC.

Disclosed herein is also a treated wastewater grit composition. The treated wastewater grit composition may comprise (i) 1%, 2%, 3%, 4%, 5%, 10%, 15%, 20%, 25%, 30%, 35%, 40%, 45%, to 50% by weight wastewater grit, (ii) about 0.1%, 0.2%, 0.3%, 0.4%, 0.5%, 0.6%, 0.7%, 0.8%, 0.9%, 1.0%. 1.1%, 1.2%, 1.3%, 1.4%, to 1.5% by weight CaO, and (iii) about 1%, 2%, 3%, 4%, 5%, 6%, 7%, 8%, 9%, 10%, 11%, 12%, 13%, 14%, 15%, 20%, to 25% by weight MgO. The treated wastewater grit composition may further include (iv) about 3%, 4%, 5%, 6%, 7%, 8%, 9%, 10%, 15%, 20%, 25%, 30%, 35%, 40%, 45%, 50%, 55%, 60%, 65%, 70%, to 75% by weight phosphate salt, for example, where the treated wastewater grit material comprises solidified material. In some embodiments, the treated wastewater grit composition may further include about 3% to 75% by weight phosphate salt.

In some embodiments, the disclosed treated wastewater grit composition includes (i) about 1% to 50% by weight wastewater grit, (ii) about 0.1% to 1.5% by weight CaO, (iii) about 1% to 25% by weight MgO, and about 3% to 75% by weight KH₂PO₄.

### ILLUSTRATIVE EMBODIMENTS

The following embodiments are illustrative and should not be interpreted to limit the scope of the claimed subject matter.

Embodiment 1. A method comprising treating wastewater grit to inactivate any pathogens that are present in the wastewater grit and forming a solidified material comprising wastewater grit.

Embodiment 2. The method of embodiment 1, wherein the solidified material comprises a chemically bonded phosphate ceramic (CBPC).

Embodiment 3. The method of embodiment 1 or 2, wherein the method comprises adding an alkaline earth metal oxide or an alkaline earth metal hydroxide to the wastewater grit.

Embodiment 4. The method of embodiment 3, wherein the alkaline earth metal oxide is selected from CaO, MgO, BeO, SrO, BaO, and any combination thereof

Embodiment 5. The method of embodiment 4, wherein the alkaline earth metal oxide comprises or consists of a combination of CaO and MgO.

Embodiment 6. The method of embodiment 3, wherein the alkaline earth metal hydroxide is selected from Ca(OH)₂, Mg(OH)₂, Be(OH)₂, Sr(OH)₂, Ba(OH)₂, and any combination thereof.

Embodiment 7. The method of any of the foregoing embodiments, wherein the method comprises adding a phosphate salt to the wastewater grit.

Embodiment 8. The method of embodiment 7, wherein the phosphate salt is selected from (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, KH₂PO₄, and any combination thereof

Embodiment 9. A method of treating wastewater grit, the method comprising: (a) obtaining wastewater grit; and (b) mixing the wastewater grit with an alkaline earth metal oxide or an alkaline earth metal hydroxide to form treated wastewater grit; wherein the method inactivates any pathogens present in the wastewater grit.

Embodiment 10. The method of embodiment 9, wherein the alkaline earth metal oxide is selected from CaO, MgO, BeO, SrO, BaO, and any combination thereof

Embodiment 11. The method of embodiment 9 or 10, wherein the alkaline earth metal oxide comprises or consists of a combination of MgO and CaO.

Embodiment 12. The method of embodiment 9, wherein the alkaline earth metal hydroxide is selected from Ca(OH)₂, Mg(OH)₂, Be(OH)₂, Sr(OH)₂, Ba(OH)₂, and any combination thereof.

Embodiment 13. The method of embodiment 9, further comprising adding a phosphate salt to the wastewater grit to produce a chemically bonded phosphate ceramic (CBPC).

Embodiment 14. The method of embodiment 13, wherein the phosphate salt compound is selected from (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, KH₂PO₄, and any combination thereof

Embodiment 15. The method of any of embodiments 9-14, wherein the treated wastewater grit has a relative high pH.

Embodiment 16. The method of any of embodiments 9-15, wherein step (b) results in increasing the pH of the wastewater grit to at least about 10.

Embodiment 17. The method of embodiment 13, wherein the treated wastewater grit comprises: (i) about 1% to 50% by weight wastewater grit, (ii) about 0.1% to 1.5% by weight CaO, (iii) about 1% to 25% by weight MgO, and (iv) about 3% to 75% by weight phosphate salt.

Embodiment 18. The method of embodiment 13, further comprising curing the CBPC at a relatively low temperature.

Embodiment 19. The method of embodiment 18, wherein the relative low temperature is a temperature of about −30° C. to about 70° C.

Embodiment 20. A method of preparing a chemically bonded phosphate ceramic (CBPC), the method comprising treating wastewater grit with an alkaline earth metal oxide or hydroxide and phosphate salt.

Embodiment 21. The method of embodiment 20, wherein the alkaline earth metal oxide is selected from CaO, MgO, BeO, SrO, BaO, and any combination thereof

Embodiment 22. The method of embodiment 21, wherein the alkaline earth metal oxide comprises or consists of a combination of MgO and CaO.

Embodiment 23. The method of embodiment 20, wherein the alkaline earth metal hydroxide is selected from Ca(OH)₂, Mg(OH)₂, Be(OH)₂, Sr(OH)₂, Ba(OH)₂, and any combination thereof.

Embodiment 24. The method of any of embodiments 20-23, wherein the phosphate salt is selected from (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, KH₂PO₄, or any combination thereof

Embodiment 25. The method of any of embodiments 20-25, wherein the treated wastewater grit comprises: (i) about 1% to 50% by weight wastewater grit, (ii) about 0.1% to 1.5% by weight CaO, (iii) about 1% to 25% by weight MgO, and (iv) about 3% to 75% by weight phosphate salt.

Embodiment 26. The method of any of embodiments 21-26, further comprising curing the CBPC at a relatively low temperature.

Embodiment 27. The method of embodiment 26, wherein the relatively low temperature is a temperature of about −30° C. to about 70° C.

Embodiment 28. A method for repairing a depression in road surface, the method comprising: (a) treating wastewater grit with an alkaline earth metal oxide or an alkaline earth metal hydroxide to form treated wastewater grit; (b) adding a phosphate salt to the treated wastewater grit to form a chemically bonded phosphate ceramic (CBPC); (c) applying the CBPC to a road surface or to a depression therein; and (d) allowing the CBPC to cure.

Embodiment 29. The method of embodiment 28, wherein the treated wastewater grit comprises: (i) about 1% to 50% by weight wastewater grit, (ii) about 0.1% to 1.5% by weight CaO, (iii) about 1% to 25% by weight MgO, and (iv) about 3% to 75% by weight phosphate salt.

Embodiment 30. Treated wastewater grit comprising: (i) about 1% to 50% by weight wastewater grit, (ii) about 0.1% to 1.5% by weight CaO, and (iii) about 1% to 25% by weight MgO.

Embodiment 31. The treated wastewater grit of embodiment 30, further comprising about 3% to 75% by weight phosphate salt.

Embodiment 32. The treated wastewater grit of embodiment 31, wherein the phosphate salt compound is selected from (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, KH₂PO₄, and any combination thereof

Embodiment 33. A method for repairing a depression in a road surface, the method comprising: (a) adding a phosphate salt to a treated wastewater grit to form a chemically bonded phosphate ceramic (CBPC), wherein the treated wastewater grit comprising wastewater grit and an added alkaline earth metal oxide or an alkaline earth metal hydroxide; (b) applying the CBPC to the depression in the road surface; and (c) allowing the CBPC to cure.

Embodiment 34. The method of embodiment 33, wherein the treated wastewater grit comprises: (i) about 1% to 50% by weight wasterwater grit, (ii) about 0.1% to 1.5% by weight CaO, (iii) about 1% to 25% by weight MgO.

Embodiment 35. The method of embodiment 33, comprising adding 3% to 75% by weight phosphate salt to the treated wastewater grit.

Embodiment 36. The method of embodiment 33, wherein the phosphate salt compound is selected from (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, KH₂PO₄, and any combination thereof.

Embodiment 37. A method for repairing a depression in a road surface, the method comprising: (a) applying an uncured CBPC to the depression in the road surface; and (b) allowing the CBPC to cure; wherein the CBPC comprises: (i) wastewater grit; (ii) an alkaline metal oxide or an alkaline metal hydroxide; and (iii) a phosphate salt.

Embodiment 38. The method of embodiment 37, wherein the treated wastewater grit comprises: (i) about 1% to 50% by weight wasterwater grit, (ii) about 0.1% to 1.5% by weight CaO, (iii) about 1% to 25% by weight MgO, and (iv) about 3% to 75% by weight phosphate salt.

Embodiment 39. The method of embodiment 38, wherein the phosphate salt compound is selected from (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, KH₂PO₄, and any combination thereof.

### EXAMPLES

The following examples are illustrative and should not be interpreted to limit the scope of the claimed subject matter.

### Example 1—Preparation of Grit-Based Chemically Bonded Phosphate Ceramic

Grit is non-biodegradable heavy solid materials that are generated during water reclamation. Grit majorly consists of sand and gravel, and also contains pathogens and some impurities such as eggshells, bone chips, seeds, coffee grounds, and large organic particles (USEPA, 2003). Large water resource recovery facilities produce a high volume of grit, and the amount can rise in winter due to the use of sand for winter maintenance (The Seattle Times, 2009). Grit is directly landfilled instead of being reused or recovered in the current practice. Landfilling is costly and unsustainable, and the reusable values of grit cannot be further tapped. Hence, there is an urgent need for a better grit disposal solution.

Chemically bonded phosphate ceramics (CBPC) is a dense and insoluble ceramic matrix of magnesium potassium phosphate hydrate which can be fabricated by the reaction: MgO+KH₂PO₄+5H₂O→MgKPO₄.6H₂O. Other alkaline earth metals' oxides or hydroxides (e.g. CaO) can also be used to form CBPC. In addition to hydrophosphates of potassium (e.g. KH₂PO₄), other typical acid-phosphates can also be used as a CBPC ingredient, including hydrophosphates of ammonia, calcium, sodium, magnesium, and aluminum (e.g. (NH₄)H₂PO₄, (NH₄)₂HPO₄, Ca(H₂PO₄)₂.H₂O, NaH₂PO₄, Mg(H₂PO₄)₂.H₂O, and AlH₃(PO₄)₂.H₂O). CBPC is an excellent and fast setting material for stabilizing and solidifying waste streams (e.g. fly ash, cement sludge, and mercury-containing waste) (Liu et al., 2008; Singh et al., 1997). As for transportation infrastructure applications such as pothole repairs, fly-ash-based CBPC has been tested at a small scale and shown good integrity with asphalt pavement in cold weather (Wagh, 2016). All the previously studied wastes are inorganic materials. However, grit is a unique mixed waste of inorganic and organic material containing infectious microorganism (i.e., pathogen), which is more complex and has never been treated using CBPC.

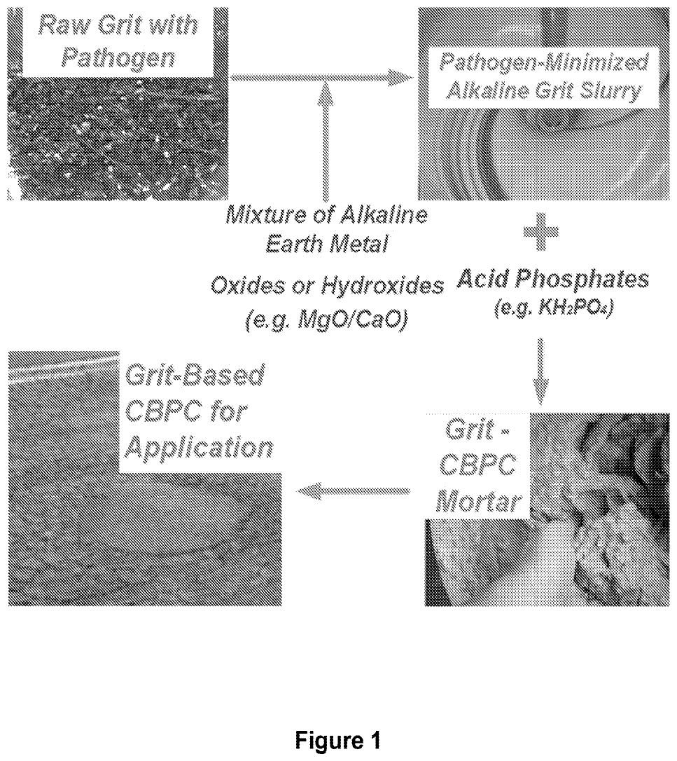

The present disclosure describes a novel method for integrating grit and CBPC for grit pathogen inactivation and grit solidification. Before synthesizing the grit-based CBPC material, the pathogens remaining in grit must be greatly reduced to protect the environment and public health. The mixture of calcium and magnesium oxides or hydroxides such as CaO/MgO mixture (i.e. CBPC ingredients) can form a high pH alkaline solution for pathogen inactivation. In particular, a small amount of calcium oxides or hydroxides (e.g. CaO) can raise pH to above 12, which is enough to kill most pathogens (Jimenez-Cisneros et al., 2001). Magnesium oxides or hydroxides (e.g. MgO) are also effective in reducing pathogens (Jin and He, 2011). The grit-CBPC mortar can be further produced by mixing pathogen-reduced alkaline grit slurry with hydrophosphates of ammonia, calcium, sodium, magnesium, aluminum, and potassium (e.g. (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, and KH₂PO₄), then grit-based CBPC material is ready to be solidified for further applications. The production and application of grit-based CBPC is illustrated in FIG. 1.

We have proven that grit pathogen can be minimized by CBPC ingredients (i.e., CaO and MgO mixture was used) and the solidified grit-based CBPC material, in which KH₂PO₄ was used as the hydrophosphate, can meet the unconfined compressive strength requirement for asphalt pavement set by the American Association of State Highway and Transportation Officials (AASHTO). Moreover, grit-based CBPC can be cured under low temperature (e.g. −10 degrees Celsius) to meet the specified compressive strength. The grit-based CBPC material (mixture of raw grit, CaO, MgO, and KH₂PO₄) can contain up to 50% raw grit by mass with satisfied compressive strength without extra additives. Assuming the average moisture content of raw grit is 80%, per the total mass of the mixture of raw grit, CaO, MgO, and KH₂PO₄, raw grit concentration varies from 1% to 50%, CaO concentration varies from 0.1% to 1.5%, MgO concentration varies from 1% to 25%, and KH₂PO₄ concentration varies from 3% to 75%. This novel treatment and disposal method can largely divert grit from landfill and convert it to useful products.

The work described below was performed to evaluate the performance of grit-based CBPC in terms of pathogen inactivation and compressive strength by varying grit loading, inactivation time, curing time, and curing temperature. The grit-based performance was compared to that of the pure CBPC material.

### Methodology

For the grit pathogen inactivation test (fecal coliform as indicator), a small amount of CaO and MgO mixture was added to raw grit with water. The amount of water depends on the grit moisture content and the total amount CBPC ingredients. The raw grit loading in the grit-based CBPC (mixture of raw grit, CaO, MgO, and KH₂PO₄) varied from 10% to 60% by mass. The fecal coliform density (i.e. CFU: colony-forming unit) of each alkaline grit slurry was analyzed using the Colilert® method (www.nemi.gov, 2017) after 1 hour, 3 hours, 6 hours, and 12 hours to determine the optimal pathogen inactivation time that meets the pathogen standard. The pathogen standard for Class A biosolids management regulated by the Wisconsin Department of Natural Resources (WDNR) was used to evaluate the inactivation effectiveness (Wisconsin State Legislature, 2011). The pathogen inactivation performance was compared to the same procedure with MgO only.

For the compressive strength test, the grit-based CBPC mortar was formed by adding KH₂PO₄ into the pathogen-reduced alkaline slurries. The mortar was cured in the mold for different durations (1, 3, 7, 14, and 28 curing days) at room temperature (20 degrees Celsius). The mortar was also cured under other temperatures (−30, −10, 0, 40, and 60 degrees Celsius) for 28 days. The compressive strength of each specimen was tested in compression by a load frame. The loading rate during the test was maintained constant at 0.02 in/min.

### Results and Discussion

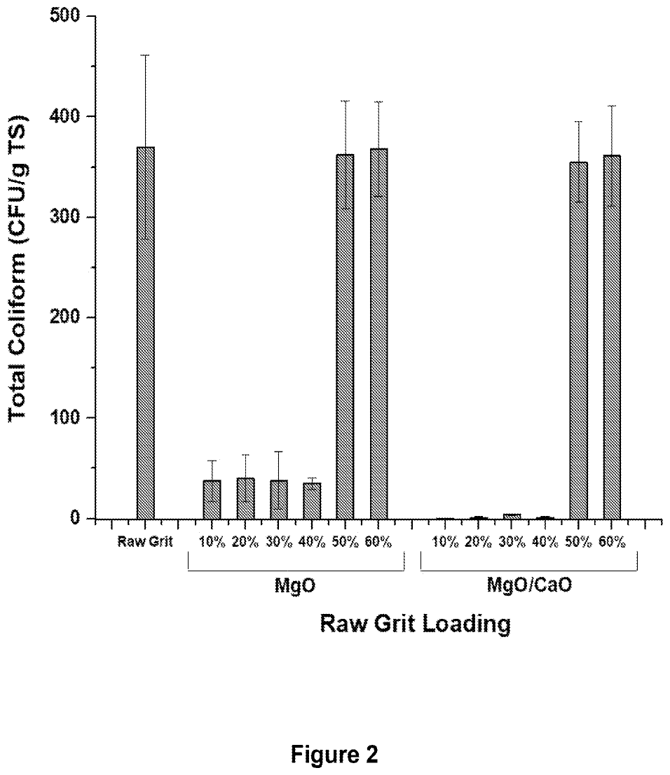

Grit pathogen densities were reduced by CaO/MgO mixture (CBPC ingredients) from 375 CFU/g TS (per gram of total solids of grit) of the raw grit to below 5 CFU/g TS of the inactivated grit with the 10-40% grit loading and 12-hour inactivation time (FIG. 2). As for the 10-40% grit loading, the pathogen densities inactivated by MgO solely were approximately 40 CFU/g TS, which were higher than those inactivated by CaO/MgO mixture. Therefore, CaO/MgO mixture should be used to minimize the grit pathogen density. The inactivated pathogen density also met the standard of 1000 CFU/g TS set by WDNR.

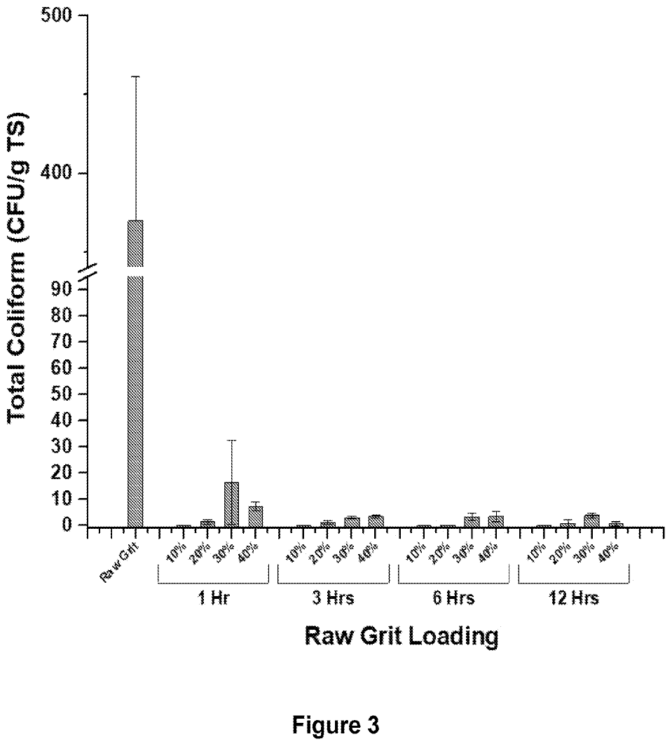

As for higher grit loadings (50% and 60%), a high-moisture slurry could not be formed since the addition of water was not necessary (i.e. grit moisture was sufficient for CBPC synthesis). Hence, the mixing between inactivation agents (CaO/MgO mixture and MgO) and grit was not good, leading to a high pathogen density similar to that of raw grit. As for the inactivation time, the pathogen density was quickly minimized within an hour and the inactivation was stable through twelve hours (FIG. 3).

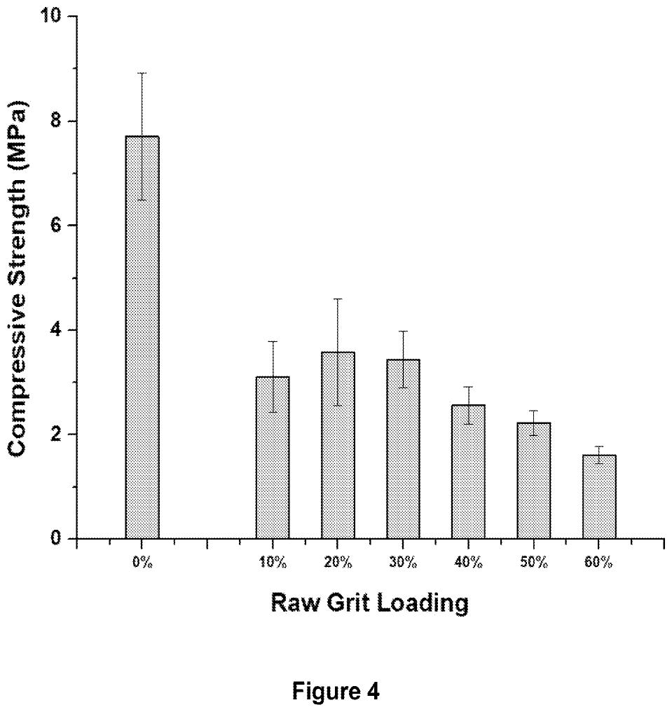

The grit-based CBPCs with the grit loading of 10-50% met the unconfined compressive strength requirement of 2.1 MPa (equal to Marshall stability of 8 kN) for asphalt pavement specified by AASHTO (Hassan and Setyawan, 2002) (FIG. 4). This compressive strength is widely used by state transportation agencies in the United States (search “Division 400 pavements” in Google). If a safety factor of 1.5 is required, only the average compressive strength of 20% and 30% grit loadings was qualified. Therefore, the recommended highest grit loading was 30% for a strength-guaranteed grit-based CBPC.

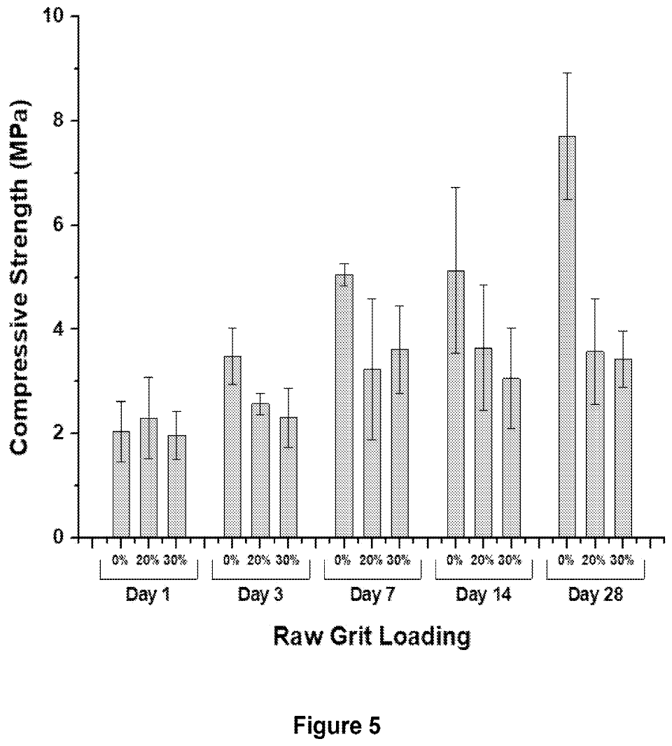

The compressive strength of the grit-based CBPC with 20% and 30% grit loadings was also monitored during 28 curing days (FIG. 5). The average grit-based compressive strength reached approximately 2 MPa in one day. The strength developed to over 2 MPa after three days and to over 3 MPa after seven days. The evolution of the grit-based compressive strength slowed down in the last 21 days. Compared to grit-based CBPC, the compressive strength of pure CBPC still increased after 7 days and was finally close to 8 MPa.

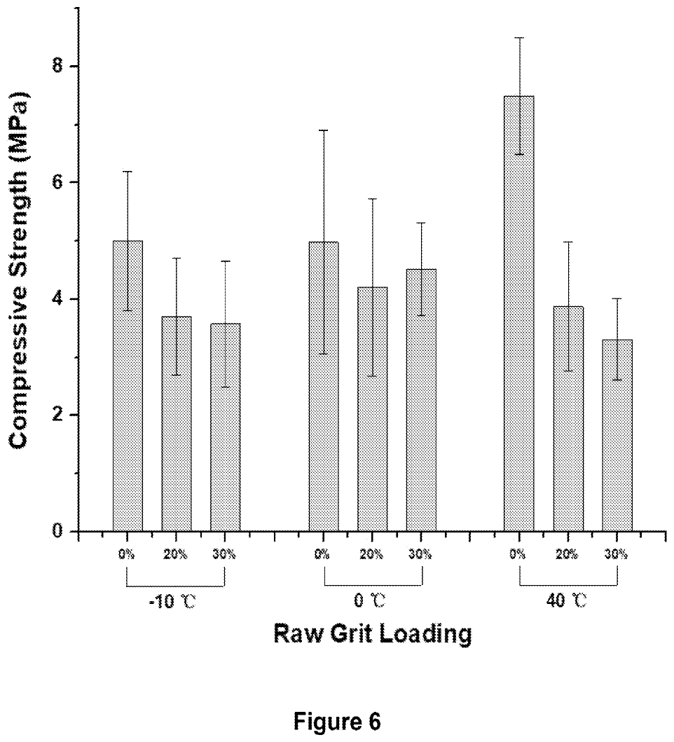

Grit-based CBPC was solidified successfully at low and high temperatures, but only the compressive strength of the specimens cured at −10, 0, and 40° C. met the requirement of 2.1 MPa for asphalt pavement (FIG. 6). As for these strength-qualified specimens, except the specimen with 30% grit loading and cured at −10° C., all the compressive strength was over 3.15 MPa (the strength with a safety factor of 1.5), indicating that the temperature impact was limited. However, under the extreme temperatures (i.e. −30° C. and 60° C.), the chemical bond formation between MgO and KH₂PO₄ was most likely retarded or partially inhibited, resulting in the fragile structure with a lower compressive strength.

### Significance

A. Grit-based CBPC is a better treatment and disposal method compared to unsustainable grit landfilling.

B. CBPC ingredients (e.g. calcium and magnesium oxides or hydroxides) can effectively minimize grit pathogen.

C. The compressive strength of grit-based CBPC meets the requirement for the asphalt pavement

D. Grit-based CBPC can be cured under cold weather with satisfied compressive strength.

### References

Hassan, K., Setyawan, A., 2002. Effect of cementitious grouts on the properties of semi-flexible bituminous pavement. Proc. 4th.

Jimenez-Cisneros, B. E., Maya-Rendon, C., Salgado-Velazquez, G., 2001. The elimination of helminth ova, faecal coliforms, Salmonella and protozoan cysts by various physicochemical processes in wastewater and sludge. Water Sci. Technol. 43.

Jin, T., He, Y., 2011. Antibacterial activities of magnesium oxide (MgO) nanoparticles against foodborne pathogens. J. Nanoparticle Res. 13, 6877-6885. doi:10.1007/s11051-011-0595-5.

Liu, Z., Qian, G., Zhou, J., Li, C., Xu, Y., Qin, Z., 2008. Improvement of ground granulated blast furnace slag on stabilization/solidification of simulated mercury-doped wastes in chemically bonded phosphate ceramics. J. Hazard. Mater. 157, 146-53. doi:10.1016/j.jhazmat.2007.12.110

Singh, D., Wagh, A. S., Cunnane, J. C., Mayberry, J. L., 1997. Chemically bonded phosphate ceramics for low-level mixed-waste stabilization. J. Environ. Sci. Heal. . Part A Environ. Sci. Eng. Toxicol. 32, 527-541. doi:10.1080/10934529709376559

The Seattle Times, 2009. Latest storm headache: Seattle sand clogs sewer plant [WWW Document].URL http://www.seattletimes.com/seattle-news/latest-storm-headache-seattle-sand-clogs-sewer-plant/(accessed 8.22.17).

USEPA, 2003. Wastewater Technology Fact Sheet Screening and Grit Removal.

Wagh, A., 2016. Chemically bonded phosphate ceramics: twenty-first century materials with diverse applications.

Wisconsin State Legislature, 2011. Chapter NR 204 DOMESTIC SEWAGE SLUDGE MANAGEMENT.

www.nemi.gov, 2017. NEMI Method Summary—Colilert [WWW Document]. URL https://www.nemi.gov/methods/method summary/5584/(accessed 8.1.17).

Wagh, A. S., Singh, D., & Jeong, S. Y. (2001). Chemically bonded phosphate ceramics for stabilization and solidification of mixed waste. Hazardous and radioactive waste treatment technologies handbook, 4(2), 127-139.

Singh, D., Wagh, A. S., Tlustochowicz, M., & Jeong, S. Y. (1998). Phosphate ceramic process for macroencapsulation and stabilization of low-level debris wastes 1. Waste Management, 18(2), 135-143.

Wagh, A. S., Jeong, S. Y., & Singh, D. (1997). Stabilization of contaminated soil and wastewater with chemically bonded phosphate ceramics (No. ANL/ET/CP-91063; CONF-970335-36). Argonne National Lab., IL (United States).

Wagh, A. S., Singh, D., & Jeong, S. Y. (2000). Mercury stabilization in chemically bonded phosphate ceramics (No. ANL/ET/CP-101487). Argonne National Lab.

Wagh, A. S., Strain, R., Jeong, S. Y., Reed, D., Krause, T., & Singh, D. (1999). Stabilization of Rocky Flats Pu-contaminated ash within chemically bonded phosphate ceramics. Journal of Nuclear Materials, 265(3), 295-307.

Colonetti, E., Kammer, E. H., & Junior, A. D. N. (2014). Chemically-bonded phosphate ceramics obtained from aluminum anodizing waste for use as coatings. Ceramics International, 40(9), 14431-14438.

Singh, D., Mandalika, V. R., Parulekar, S. J., & Wagh, A. S. (2006). Magnesium potassium phosphate ceramic for 99Tc immobilization. Journal of Nuclear Materials, 348(3), 272-282.

Method for stabilizing low-level mixed wastes containing tritium or cesium at room temperature: Wagh, A. S., & Singh, D. (1997). U.S. Pat. No. 5,645,518.

Method of waste stabilization (e.g. radioactive waste) via CBPC: Wagh, A. S., Singh, D., & Jeong, S. Y. (1998). U.S. Pat. No. 5,830,815.

Phosphate bonded structural products from high volume wastes, Singh, D., & Wagh, A. S. (1998). U.S. Pat. No. 5,846,894.

Method for producing CBPC and for stabilizing contaminants (i.e. metal ions) encapsulated therein utilizing reducing agents: Singh, D., Wagh, A. S., & Jeong, S. Y. (2000). U.S. Pat. No. 6,133,498.

CBPC based on fly ash: Colorado, H. A., & Yang, J. M. (2014). U.S. Pat. No. 8,911,548.

CBPC sealant formulations for oil field applications (e.g. oil field waste): Wagh, A. S., Jeong, S. Y., & McDaniel, R. (2008). U.S. Pat. No. 7,438,755.

Aluminum Phosphate Ceramics for Waste Storage (e.g. radioactive waste): Wagh, A., & Maloney, M. D. (2014). U.S. Pat. No. 8,742,195.

Barinov, S .M., Komlev, V. S., 2011. Calcium phosphate bone cements. Inorg. Mater. 47, 1470- 1485. doi:IO.l 134/S0020168511130024

Jauberthie, R., Rendell, F., Tamba, S., Cisse, I. K., 2003. Properties of cement-rice husk mixture. Constr. Build. Mater. 17, 239-243. doi:I0.1016/S0950-0618(03)00005-9

Kleen Construction, 2016. What Is Cold Mix Asphalt? FAQ About Cold Mix Asphalt [WWW Document]. URL http://kleencoconstruction.com/news/cold-mix-asphalt-faq-cold-mix-asphalt/

Milwaukee Journal Sentinel, 2014. This time in Milwaukee last year: 667 potholes. This year: 997. URL http ://archive.jsonline. com/news/milwaukee/this-time-in-milwaukee-last-year-667-potholes-this-year-nearly-1000-b99203048z1-244885731.html/.

Mo, W., Zhang, Q., 2013. Energy-nutrients-water nexus: integrated resource recovery in municipal wastewater treatment plants. J. Environ. Manage. 127, 255-67.

Sainz, M., 2016. Pothole Patching: A Review on Materials and Methods.

Smith & Loveless Inc, 2012. Fundamentals of Grit Removal and Grit System Evaluation_Part 2. URL https://www.scribd.com/document/203386286/Fundamentals-of-Grit-Removal-and-Grit-System-Evaluation-Part-2-Color-Very-Good

Soroushian, P., Marikunte, S., Won, J., 1994. Wood Fiber Reinforced Cement Composites under Wetting-Drying and Freezing-Thawing Cycles. J. Mater. Civ. Eng. 6, 595-61 I.

Tanniru, M., Misra, R. D. K., 2005. On enhanced impact strength of calcium carbonate-reinforced high-density polyethylene composites. Mater. Sci. Eng. A 405, 178-193. doi:10.1016/j.msea.2005.05.083

USEPA, 1992. Method 1311 Toxicity Characteristic Leaching Procedure. URL https://www.epa.gov/sites/production/files/2015-12/documents/131I.pdf (accessed 8.2.17

Wisconsin Administrative Code, Chapter NR 204 DOMESTIC SEWAGE SLUDGE MANAGEMENT.

Partial oxidation of sewage sludge, U.S. Pat. No. 4,983,296A

Permafrost ceramicrete, US20050160944A1

Method of using wastewater sludge in the production of concrete, US20060112861A1

RAO, “Stabilization and Solidification of Metal-Laden Wastes by Compaction and Magnesium Phosphate-Based Binder,” Journal of the Air & Waste Management Association, Volume 50, 2000, Issue 9, 1623-1631

KULKARNI, “GRIT REMOVAL & TREATMENT for Sustainable Grit Recycling,” Indian Environmental Association EnviroVision 2011

MI, “New possibilities of Magnesium utilization in wastewater treatment and nutrients recovery,” DiVA, 2009. , p. 38.

JHANSI, “Wastewater Treatment and Reuse: Sustainability Options,” Consilience: The Journal of Sustainable Development, Vol. 10, Iss. 1 (2013), Pp. 1-15

GARDNER, “Characterisation of magnesium potassium phosphate cements blended with fly ash and ground granulated blast furnace slag,” Cement and Concrete Research, 74, (2015), 78-87.

BORGES, “Characterization of residual sand removed from the grit chambers of a wastewater treatment plant and its use as fine aggregate in the preparation of non-structural concrete,” Water Practice & Technology 10(1):164 March 2015

MATAR, “Use of wastewater sludge in concrete mixes,” The Islamic University of Gaza, High Studies Deanery, Faculty of Engineering Civil Engineering, Department Design and Rehabilitation of Structures, Thesis, February 2008

GOMEZ, “Analysis of possible use of sewage sludge in cement based composites mix design,” Final Degree Project Building Engineering, July 2014

### Example 2—Scaled-Up Experiments of Grit Assisted Patches (GAP)

### Using Centrifuged Wastewater Grit

The use of chemically bonded phosphate ceramic (CBPC) as disclosed herein for repairing potholes as a Grit Assisted Patch (GAP) was studied in a scaled-up experiment. Raw grit with water was placed in a centrifuge to separate water and light organic components from the heavy particles (mainly inorganic particles and was called inorganic particles in this research). The separated water and light organic components were disposed. The inorganic particles were used for GAP synthesis with different loadings (10%, 20%, 30%, 40%, 50%, 60% by mass). The compressive strength of each specimen was measured after 1, 3, 7 and 28 curing days, respectively, under room temperature. It was found that the compressive strength of GAP specimens with inorganic particles was similar to that of specimens with raw grits if they had same solid grit loading by mass. However, the centrifuged grit did not have the strong smell as that of raw grit, occupied much smaller storing space, and could be kept in room temperature for relatively long period without growing mold.

### Long-Term Stability of Inactivated Grit

The pathogen density analysis was conducted using Standard Method 9223B to evaluate the long-term pathogen density of raw and inactivated grits. A small amount of calcium oxide (CaO) was added to raw grit and mixed to achieve a homogenous slurry to obtain inactivated grit. The pathogen densities of both raw and inactivated grits were evaluated at 1, 3, 7, 14, and 28 days, respectively. Analysis for Day 1 demonstrated a raw grit pathogen density of 1.9×10⁵±2.5×10⁴ cfu/100 mL, and the alkaline slurry of 1.5×10²±2.0×10² cfu/100 mL. Day 3, the raw grit pathogen density was 1.6×10⁵±7.8×10⁴ cfu/100 mL, with the alkaline slurry having no detectableb colonies. The inactivated grits remained at non-detectable levels for the remainder of the long-term study. Day 7, Day 14, and Day 28 demonstrated a raw grit of 6.0×10²±2.0×10² cfu/100 mL, 1.1×10²±5.9×10¹ cfu/100 mL, and 1.3×10²±8.8×10′ cfu/100 mL, respectively. Therefore, CaO could effectively inactivate the pathogens in grits and the inactivated grits were stable for long-term storage.

### Formulating Color of GAP

Black pigment powder was used to change the color of GAP to make it more compatible with asphalt pavement aesthetically. The compressive strengths of the color-formulated samples were measured after 3 and 21 curing days under room temperature. The formulated colors were compared with those of aged and new asphalt pavements. The pigment-added samples had dark grey color, which was close to that of aged asphalt pavement. As for the compressive strength, the compressive strength of color-formulated samples was similar to that of the control sample and met the requirement of 2.1 MPa for asphalt pavement application.

### Field Testing of the GAP

Three potholes on the roads at the South Shore Water Reclamation Facility (Oak Creek, WI) were selected to be repaired by GAP. These potholes were located on a parking lot, light-traffic load and heavy traffic load, respectively, to study the performance of GAP in field subjected to real environment and different traffic conditions. The debris in the potholes was removed by vacuum before the GAP repairment. The following pictures show before and after GAP repairment of a pothole.

In the foregoing description, it will be readily apparent to one skilled in the art that varying substitutions and modifications may be made to the invention disclosed herein without departing from the scope and spirit of the invention. The invention illustratively described herein suitably may be practiced in the absence of any element or elements, limitation or limitations which is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scope of this invention.

Citations to a number of patent and non-patent references are made herein. The cited references are incorporated by reference herein in their entireties. In the event that there is an inconsistency between a definition of a term in the specification as compared to a definition of the term in a cited reference, the term should be interpreted based on the definition in the specification.

We claim:

1.-8. (canceled)

9. A method of treating wastewater grit, the method comprising:
(a) obtaining wastewater grit;
(b) mixing the wastewater grit with an alkaline earth metal oxide or an alkaline earth metal hydroxide to form treated wastewater grit;
wherein the method inactivates any pathogens present in the wastewater grit.

10. The method of claim 9, wherein the alkaline earth metal oxide is selected from CaO, MgO, BeO, SrO, BaO, and any combination thereof.

11. The method of claim 10, wherein the alkaline earth metal oxide comprises or consists of a combination of MgO and CaO.

12. The method of claim 9, wherein the alkaline earth metal hydroxide is selected from Ca(OH)₂, Mg(OH)₂, Be(OH)₂, Sr(OH)₂, Ba(OH)₂, and any combination thereof.

13. The method of claim 9, further comprising adding a phosphate salt to the wastewater grit to produce a chemically bonded phosphate ceramic (CBPC).

14. The method of claim 13, wherein the phosphate salt compound is selected from (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, KH₂PO₄, and any combination thereof

15. (canceled)

16. The method of claim 9, wherein step (b) results in increasing the pH of the wastewater grit to at least about 10.

17. The method of claim 13, wherein the treated wastewater grit comprises:
(i) about 1% to 50% by weight wastewater grit,
(ii) about 0.1% to 1.5% by weight CaO,
(iii) about 1% to 25% by weight MgO, and
(iv) about 3% to 75% by weight phosphate salt.

18.-19. (canceled)

20. A method of preparing a chemically bonded phosphate ceramic (CBPC), the method comprising treating wastewater grit with an alkaline earth metal oxide or alkaline metal hydroxide and a phosphate salt.

21. The method of claim 20, wherein the alkaline earth metal oxide is selected from CaO, MgO, BeO, SrO, BaO, and any combination thereof.

22. The method of claim 21, wherein the alkaline earth metal oxide comprises or consists of a combination of MgO and CaO.

23. The method of claim 20, wherein the alkaline earth metal hydroxide is selected from Ca(OH)₂, Mg(OH)₂, Be(OH)₂, Sr(OH)₂, Ba(OH)₂, and any combination thereof.

24. The method of claim 20, wherein the phosphate salt is selected from (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, KH₂PO₄, or any combination thereof

25. The method of claim 20, wherein the treated wastewater grit comprises:
(i) about 1% to 50% by weight wastewater grit,
(ii) about 0.1% to 1.5% by weight CaO,
(iii) about 1% to 25% by weight MgO, and
(iv) about 3% to 75% by weight phosphate salt.

26. The method of claim 20, further comprising curing the CBPC at a relatively low temperature.

27. (canceled)

28. A method for repairing a depression in road surface, the method comprising I:
(a) treating wastewater grit with an alkaline earth metal oxide or an alkaline earth metal hydroxide to form treated wastewater grit;
(b) adding a phosphate salt to the treated wastewater grit to form a chemically bonded phosphate ceramic (CBPC);
(c) applying the CBPC to a road surface or to a depression therein; and
(d) allowing the CBPC to cure; or
the method comprising II:
(a) adding a phosphate salt to a treated wastewater grit to form a chemically bonded phosphate ceramic (CBPC), wherein the treated wastewater grit comprising wastewater grit and an added alkaline earth metal oxide or an alkaline earth metal hydroxide;
(b) applying the CBPC to the depression in the road surface; and
(c) allowing the CBPC to cure; or the method comprising III:
(a) applying an uncured CBPC to the depression in the road surface; and
(b) allowing the CBPC to cure;
wherein the CBPC comprises:
wastewater grit
(ii) an alkaline metal oxide or an alkaline metal hydroxide; and
(iii) a phosphate salt.

29. The method of claim 28, wherein the treated wastewater grit comprises:
(i) about 1% to 50% by weight wastewater grit,
(ii) about 0.1% to 1.5% by weight CaO,
(iii) about 1% to 25% by weight MgO, and
(iv) about 3% to 75% by weight phosphate salt.

30. Treated wastewater grit comprising:
(i) about 1% to 50% by weight wastewater grit,
(ii) about 0.1% to 1.5% by weight CaO, and
(iii) about 1% to 25% by weight MgO.

31. The treated wastewater grit of claim 30, further comprising about 3% to 75% by weight phosphate salt.

32. The treated wastewater grit of claim 31, wherein the phosphate salt compound is selected from (NH₄)H₂PO₄, (NH₄)₂HPO₄, Ca(H₂PO₄)₂.H₂O, NaH₂PO₄, Mg(H₂PO₄)₂.H₂O, AlH₃(PO₄)₂.H₂O, KH₂PO₄, and any combination thereof.

33.-39. (canceled)
